(19) United States
(12) Patent Application Publication
(10) Pub. No.: US 2009/0240551 A1
(43) Pub. Date: Sep. 24, 2009

(54) SERVICE ALIGNMENT SYSTEM AND METHOD

(75) Inventors: David J. Writz, Mequon, WI (US); Patrick M. Foley, Mukwonago, KS (US); Stephen P. Telo, Jacksonville, FL (US); Marc D. Andraca, Whitefish Bay, WI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 12/200,815

(22) Filed: Aug. 28, 2008

Related U.S. Application Data
(60) Provisional application No. 60/966,833, filed on Aug. 30, 2007.

(51) Int. Cl. G06Q 10/00; G06Q 50/00

(52) U.S. Cl. 705/9; 705/7

(57) ABSTRACT

A method for creating and executing a service strategy using a service alignment system includes updating a skill set of a service professional available to perform service and defining a service team, wherein service professionals may be assigned to the service team. The method further includes assigning the service team to a contract, updating service obligations associated with the contract, assigning a service professional available to perform service to the service team assigned to the contract by matching a skill of the service professional to an updated service obligation of the contract, storing and executing the team and service professional assignments using the service alignment system.

### CROSS-REFERENCE TO RELATED APPLICATIONS

The present application claims the benefit of U.S. Provisional Patent Application No. 60/966,833, filed Aug. 30, 2007, the entire disclosure of which is incorporated by reference.

### BACKGROUND

This application generally relates to service management systems and methods. This application relates more specifically to service alignment systems and methods of aligning service resources with service obligations.

Service providers generally provide services to customers. Services generally entail supplying some level of know-how, skill, experience, and/or time to complete a service task for a customer. For example, in the heating, ventilation, and air conditioning (“HVAC”) or building services industries, service professionals may complete service tasks relating to installing, repairing, checking, and/or otherwise maintaining HVAC components, security systems, or other building services components.

Consumers of services often have varying or different service requirements, needs, or expectations. These differing service requirements may drive the need for service providers to employ service professionals having different skill sets within the same basic service category. For example, in the HVAC services industry, one customer may frequently require skills relating to boiler equipment while another customer may not require boiler skills but may instead require a service professional having chiller skills. Furthermore, depending on the scope of each customer's required service work, some customers may demand more service professional hours than others.

In many industries, the details of customer service requirements or expectations are defined in service contracts between the customer and the service provider. The service contracts result in the creation of service obligations that the service provider is obligated to fulfill for the customer. The service obligations may include guidelines regarding, for example, what types of services to conduct, how often to conduct the services, and the price of the services.

If a service provider employs more than one service professional and is obligated to provide services to more than one customer, choices regarding how to meet all of the service provider's service obligations arise. While small or unsophisticated service providers may resolve service choices “on the fly,” or with minimal planning, it has been discovered that advance planning and systematic planning often results in higher degrees of customer satisfaction and service provider efficiency.

Modern service providers typically use a computerized system having scheduling software to track planned and unplanned service visits. These software packages are often “calendar” applications and typically provide an indication related to which service professionals are available on certain days or at certain hours. Other software packages might track service obligations in the form of trouble tickets and assign the tickets to service professionals on a daily or “first available” basis. These software packages, however, are typically rather disconnected, are not well integrated, and do not take into account various specific needs related to known service obligations. For example, using one software application that lists service requests and a separate scheduling application, a service manager may attempt to arrange the calendars of his or her service professionals. While some service managers may achieve good results using such a system, there is typically substantial room for optimization or improvement. Despite the best efforts of a manager, typical systems and conventional methods of organizing service resources and service obligations leave much for service managers to consider beyond mere scheduling. Using these typical systems, it may be difficult for the manager to determine what service resources are needed to meet all customers' specific service expectations and needs. This gap between customers' specific service expectations and needs and the resources planning or organizing capabilities of conventional systems may result in unmet customer needs, under-qualified workers servicing certain equipment, difficulty communicating schedules to customers, difficulty forecasting labor demand, difficulty forecasting service agreement profit margins, and other difficulties.

It would be desirable to provide a service management system that assists a service manager in organizing service resources. It would further be desirable to provide a service management system that assists a service manager in organizing service obligations. It would further be desirable to provide a system and method that allow a service manager to determine which service resources are required to meet service obligations. It would further be desirable to provide a method for forecasting labor demand and service agreement profit margins.

What is needed is a system and/or method that satisfies one or more of these needs or provides other advantageous features. Other features and advantages will be made apparent from the present specification. The teachings disclosed extend to those embodiments that fall within the scope of the claims, regardless of whether they accomplish one or more of the aforementioned needs.

### SUMMARY

One embodiment relates to a method for creating and executing a service strategy using a service alignment system. The method includes updating a skill set of a service professional available to perform service and defining a service team, wherein service professionals may be assigned to the service team. The method further includes assigning the service team to a contract, updating service obligations associated with the contract, assigning a service professional available to perform service to the service team assigned to the contract by matching a skill of the service professional to an updated service obligation of the contract, storing and executing the team and service professional assignments using the service alignment system.

Another embodiment relates to a system for aligning service obligations with service resources. The system includes one or more databases communicably coupled to a computer system. The one or more databases include a service obligations data set comprising a set of contracts and defined service obligations for each contract, and a service resources data set comprising a plurality of service teams and service professionals. The system further includes a service alignment engine configured to functionally access the one or more databases, assign each contract to a service team, and to build the service team by assigning service professionals to the service team; wherein the service alignment engine is further configured to iterate a computer system user through a process of refining the service professional to service team assignments if the service alignment engine estimates that the defined service obligations for each contract will not be adequately served by the team assigned to the contract. The system further includes a scheduling system configured to receive and execute the assignments.

Alternative exemplary embodiments relate to other features and combinations of features as may be generally recited in the claims.

### BRIEF DESCRIPTION OF THE FIGURES

The application will become more fully understood from the following detailed description, taken in conjunction with the accompanying figures, wherein like reference numerals refer to like elements, in which:

FIG. 1 is block diagram providing an overview of how a service alignment system may be used to manage service obligations and resources of a service provider, according to an exemplary embodiment;

FIG. 2 is block diagram of a service alignment system, according to an exemplary embodiment;

FIG. 3 is block diagram of a service alignment system, according to an exemplary embodiment;

FIG. 4 is a detailed block diagram of a service alignment system, according to an exemplary embodiment;

FIG. 5A is flow chart illustrating a process of using a service alignment system, according to an exemplary embodiment;

FIG. 5B is a more detailed flow chart illustrating a process of using a service alignment system, according to an exemplary embodiment;

FIG. 6 is a detailed flow chart illustrating a process of using a service alignment system, according to another exemplary embodiment;

FIG. 7 is a flow chart further illustrating step 610 of FIG. 6, according to an exemplary embodiment.

### DETAILED DESCRIPTION OF THE EXEMPLARY EMBODIMENTS

Before turning to the figures which illustrate the exemplary embodiments in detail, it should be understood that the application is not limited to the details or methodology set forth in the following description or illustrated in the figures. It should also be understood that the phraseology and terminology employed herein is for the purpose of description only and should not be regarded as limiting.

Referring generally to the figures, a service alignment system is shown that provides a graphical user interface to a user (e.g., usually a service manager, service operations agent, or other employee of a service providing entity). The service alignment system is generally an integrated software tool that may prompt or otherwise drive the user through a process of defining service obligations and service resources in detail. These definitions are stored in one or more databases for later retrieval and use. The system may then assign or assist the user in assigning service resources to service obligations by matching the defined properties of the service resources with service obligations. The system may provide feedback to the user and iterate the user through a process of changing or adding assignments until the system determines or displays that all service obligations will be adequately met by assigned service resources. Using such a process, a service manager may optimize or improve service efficiency and customer satisfaction by providing appropriately skilled and/or available service professionals to meet service obligations.

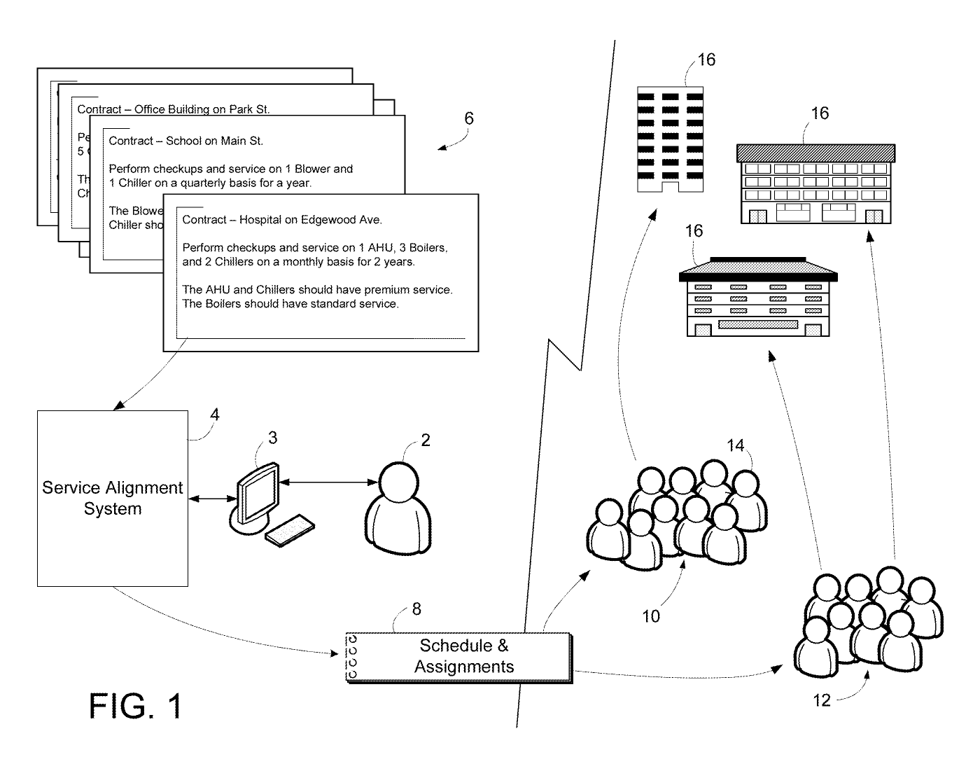

Referring to FIG. 1, a block diagram is shown that provides an overview of how a user 2 may interact with a service alignment system 4 via input/output device 3 to schedule and assign a service branch's resources to meet various service obligations. A user 2 of a service alignment system 4 will often be a service manager or service operations agent of a service branch or other service providing organization. The service provider may enter into a plurality of contracts with customers and these contracts may collectively create a set of service obligations 6 that the service branch is obligated to serve or meet. Service obligations 6 may be detailed and stored in a database of service alignment system 4. Service alignment system 4 may also store or access a database of service resources the service provider may assign to service obligations. Service alignment system 4 may generate or help user 2 create optimized schedules and assignments 8 that may be executed, given, or assigned to service teams 10 and 12. Each service team 10 and 12 may be made of one or more individual service professionals 14. Based on generated or optimized schedules and assignments 8, service teams 10 and 12 may include a number or mix of service professionals necessary to effectively and efficiently meet the needs of customers or customer locations 16.

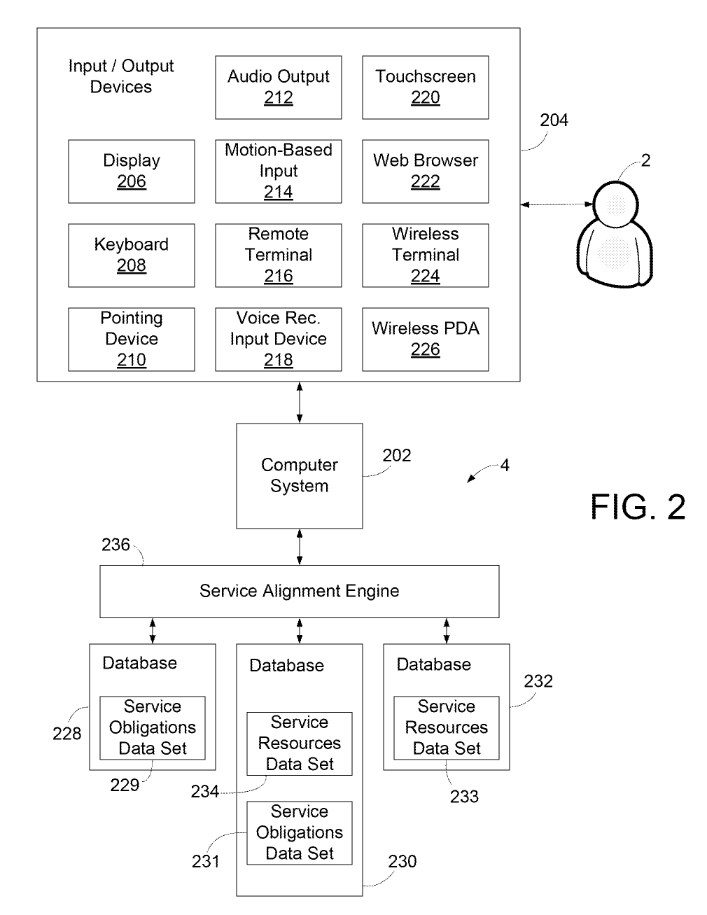

Referring to FIG. 2, a block diagram of a service alignment system 4 is shown, according to an exemplary embodiment. Service alignment system 4 may include a computer system 202 coupled to or having a variety of input and/or output devices 204. Input and output devices 204 may include, for example, display 206, keyboard 208, pointing device 210, audio output 212, motion-based input device 214, remote terminal 216, voice recognition input device 218, touch screen 220, web browser 222, wireless terminal 224, and/or wireless personal data device 226 (e.g., personal digital assistant, data-enabled cellular telephone, wireless tablet, ultra-portable laptop, etc.). Computer system 202 may be any computerized system, distributed system, stand-alone system, or otherwise of the past, present or future that may be configured to implement the activities and/or interfaces of the various exemplary service alignment systems and methods described within this application. For example, in a stand-alone system, computer system 202 may be a single computer configured to execute local applications to provide the service alignment system of the present application. In a distributed system, by way of further example, a server computer or computers may execute server-side applications and database systems and provide an interface, such as a web-based interface, to a client computer or terminal having a web-browser.

Referring further to FIG. 2, service alignment system 4 may also include one or more databases 228, 230, and 232. One or more of databases 228, 230, and 232 may be communicably coupled to or otherwise in communication with computer system 202. According to one exemplary embodiment, databases 228, 230, and 232 reside in a memory or storage device of computer system 202 and are generally managed by a database management system also residing in computer system 202. As shown, one or more databases 228, 230, and 232 may include, among other data sets, tables, and/or sub-databases, service obligations data set 229 or 231 and service resources data set 233 or 234. As illustrated in FIG. 2, multiple service obligation data sets and/or service resources data sets may exist in service alignment system 4 and separate databases may be provided for different data sets.

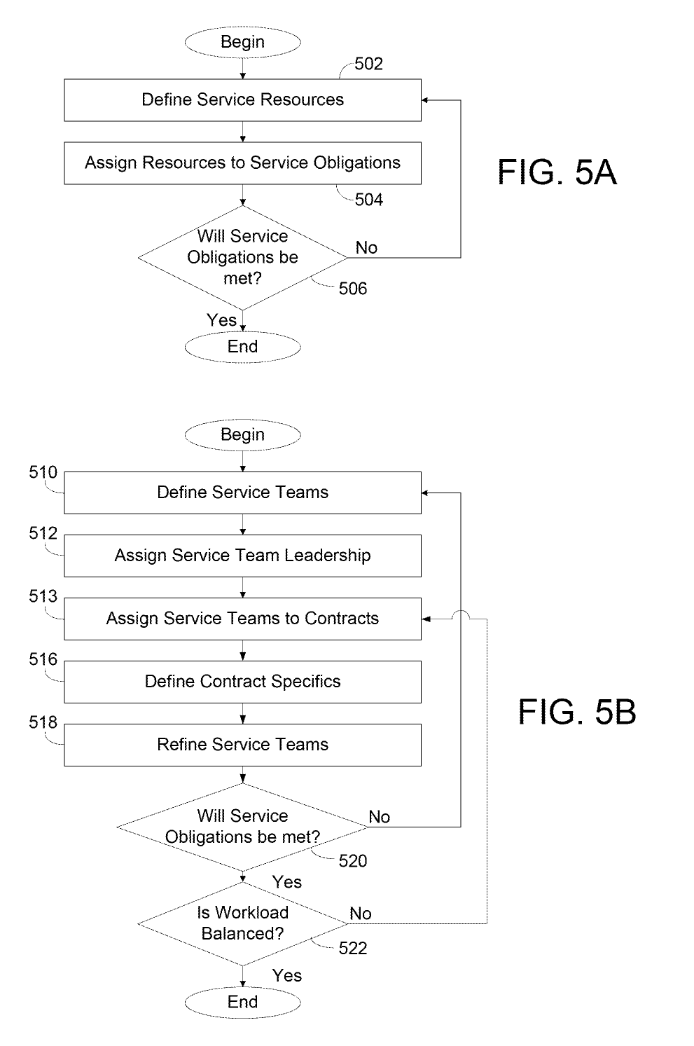

Referring yet further to FIG. 2, a service alignment system 4 also includes service alignment engine 236. Service alignment engine 236 may be a software application or applications, one or more software scripts, a standalone computer system, or any other hardware and/or software configured to execute the system activities or methods herein described (e.g., the processing or determining steps of FIGS. 5A-7). Service alignment engine 236 is generally configured for use with computer system 202 and is also configured to functionally access one or more databases 228, 230, and 232. Service alignment engine 236 is also generally configured to use data input and output devices 204 to iterate user 2 through a process of assigning service resources to service obligations. Service alignment engine 236 may further provide feedback to the user through devices 204 to indicate whether or not all service obligations of a service obligations data set have been sufficiently assigned service resources of a service resource data set. According to any preferred embodiment, service alignment engine 236 is configured to provide processing, interfaces, inputs and outputs, and methods to service alignment system 4 and user 2 as generally described in this application.

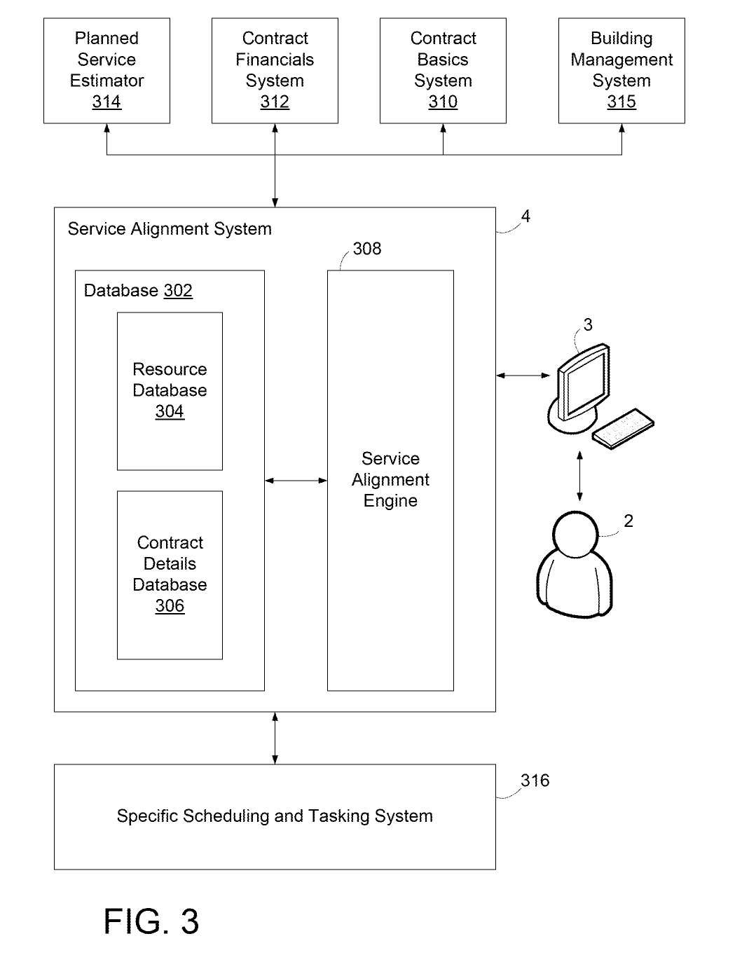

Referring to FIG. 3, a block diagram of a service alignment system 4 is shown, according to various exemplary embodiments. User 2 may interact with input/output device 3 such that input/output device 3 may obtain data input from user 2 and provide data output to user 2. Service alignment system 4 may generally be connected or networked to input/output device 3. Input/output device 3 may be displaying graphical user interfaces of service alignment system 4 to user 2. Service alignment system 4 may include database 302, resource database 304 and contract details database 306. Service alignment system 4 may also be coupled or otherwise connected to a variety of other systems or databases. For example, service alignment system 4 may be coupled or networked to contract basics system 310, contract financials system 312, planned service estimator 314, building management system 315, and specific scheduling and tasking system 316. According to various alternative embodiments, service alignment system 4 may include systems 310, 312, 314, 315, and 316 or be coupled to fewer, more, or alternative systems. Service alignment engine 308 may generally allow user 2 to receive contract basics from contract basics system 310, further define contract details and store the defined details in contract details database 306. Engine 308 and user 2 may then distribute responsibility for the various defined contracts (i.e., service obligations) to service professionals or service teams that have been identified, defined, and stored in resource database 304.

Contract basics system 310 may generally be a database system or application configured to store basic details about the contracts or other service obligations of a service provider. Contract basics system 310 may store, for example, client names, locations of contract service locations or customers, basic contract coverage, contract type, equipment types being serviced, price, duration, and any other data that may be found on the face of a service contract or otherwise related to a service contract. Contract financials system 312 may generally be a database system or application storing details about the financial aspect of the contracts of the service branch. Contract financials system 312 may specify, for example, certain discounts, agreed prices, tiering price structures, hourly rates, whether equipment is included or not, overtime rates, emergency rates, travel rates, budget targets, and any other financial information that may relate to a service contract. Planned service estimator 314 may generally be an application that estimates service needs of customers, identifies new service opportunities for the service branch, and/or assists with the contract renewal processes of the service branch.

According to various exemplary embodiments, service alignment system 4 may also be communicably coupled to building management system 315. For example, service alignment system 4 may be connected to a building management system such as a METASYS® Building Management System sold by Johnson Controls, Inc. Using this connection, service alignment system 4 may download, receive, or otherwise read detailed contract-related data from building management system 315. For example, service management system 4 may read detailed information about the HVAC or security equipment that may be serviced at a contract site using the connection to building management system 315. Service management system 4 may use this information to build a detailed list or catalog of equipment that may need to be serviced under a contract in contract details database 306. This catalog may be populated by service alignment system 4 and may include building zone information for the equipment, diagnostic information, specific identifier information (e.g., type, model, age, serial number, etc.), and other information related to the building management devices of building management system 315. According to various other embodiments, service alignment system 4 may query a plurality of Internet connected building management systems 315 to populate and extract detailed equipment information for a plurality of contracts and/or contract sites. Building management system 315 may also send trigger information to planned service estimator 314, contract basics system 310, and/or service alignment system 4 if the building management system determines that a coupled component of the HVAC or security system has failed or requires service. According to various embodiments, users of building management system 315 may send service requests to service alignment system 4 and/or update their contracts (e.g., order additional services, upgrade service, downgrade service, etc.) via a user interface of building management system 315. Building management system 315 may then forward the updated service or contract information to service alignment system 4 or connected systems (e.g., scheduling and tasking system 316, contract financials 312, etc.) and update contract details database 306 accordingly. Building management system 315 may also send equipment updates to contract details database 306 as new equipment is brought online and/or old equipment is decommissioned or updated.

User 2 may generally interact with user interfaces provided by input/output device 3 to populate contract details database 306 and resource database 304. Once populated, or during population, user 2 or service alignment engine 308 may make resource optimization decisions. These resource optimization decisions are output or provided to a specific scheduling and tasking system 316 that service professionals, service agents, and/or service teams of the service branch use to specifically schedule and complete service tasks.

Resource database 304 includes information regarding service professionals (e.g., front line service professionals, agents, foremen, contractors, specialists, etc.) who may be assigned to complete service work for the service provider. More specifically, information stored in resource database 304 may include information regarding the contact information for each service professional, the role of each service professional, the skills of each service professional, and/or various other information such as the number of hours each service professional is available during a week, the days of the week available, how far the service professional is willing to travel, and any other information that the service provider may use to match service professionals with service obligations.

Contract details database 306 may generally include information regarding the sites or facilities associated with each contract, the equipment at each site or facility, a detailed catalog of equipment that is covered by the contract, the types of service to be performed, any optional services or levels of service that will be performed on the equipment, any equipment specific information, a catalog of other equipment or requirements relating to the service needs of the contract, customer, and/or equipment.

Service alignment system 4 may use inputs from contract basics system 310, contract financials database 312, planned service estimator 314, and/or any number of additional inputs (e.g., manual inputs from a service operations agent, service manager, working foreman, schedule requests from customers, etc.) to populate or provisionally populate the information of contract details database 306.

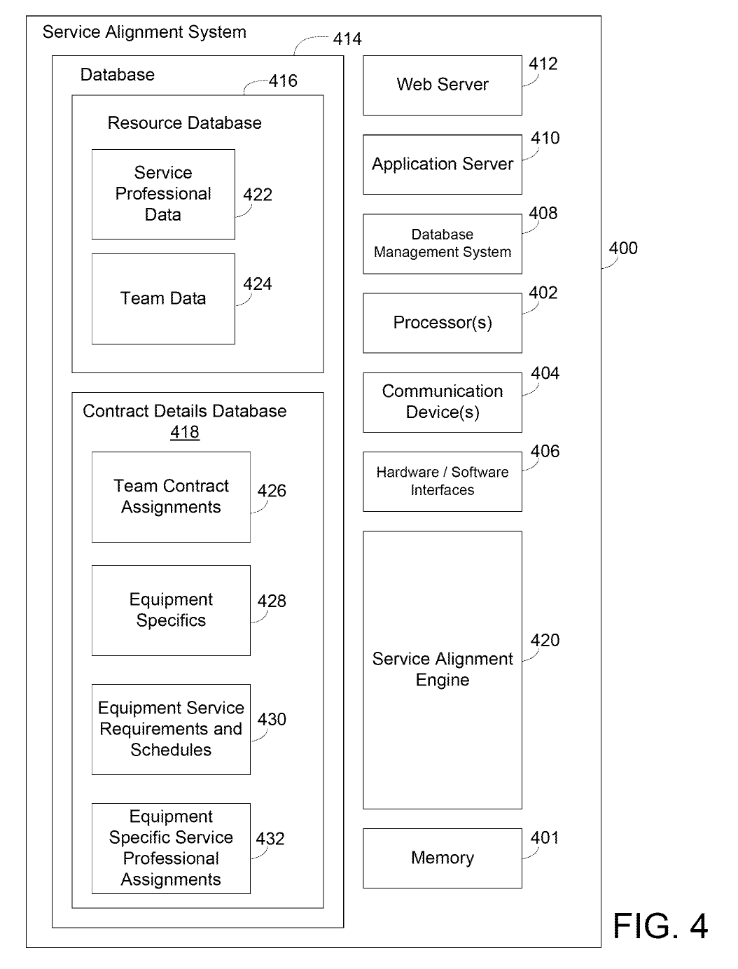

Referring to FIG. 4, a detailed block diagram of a service alignment system 400 is shown, according to an exemplary embodiment. Service alignment system 400 is implemented in a computer system that is a server or workstation configured to provide or serve user interfaces to other connected client devices. Each service branch of a service entity may have its own service alignment system 400, or the hardware and software of the system may be shared and/or located at some district office, headquarters, or other remote location. According to one embodiment, the server implementing service alignment system 400 includes one or more processors 402, memory or storage devices 401, one or more communications devices 404, one or more additional hardware or software interfaces 406 to other networks, devices, or peripherals, a database management system 408, an application server 410, and/or a web server 412.

Referring further to FIG. 4, database 414 includes resource database 416 and contract details database 418. These databases are generally managed and/or accessed by service alignment system 400 via database management system 408 and/or application server 410 or web server 412. The databases are generally stored in a memory or storage device or devices of service alignment system 4. The databases of service alignment system 400 may generally be any type of database suitable for the organized storage and retrieval of information and data. For example, the databases of service alignment system 400 may be relational databases, flat databases, hierarchical databases, XML databases, object-oriented databases, and/or a combination of database types.

According to the exemplary embodiment shown in FIG. 4, resource database 416 may include service professional data 422 and team data 424. Service professional data 422 may contain contact information, skills of each service professional, a skill level for each skill, location information, and/or any other information that may be relevant to a service manager when allocating tasks to service professionals or employees. Team data 424 may include the number and types of teams needed to serve the customers of a service branch. For example, team data 424 may include team names, team numbers or other team identifiers, a team description, employees assigned to the team, employee rolls within the team, and/or other information that may generally relate to any given team.

Referring yet further to FIG. 4, contract details database 418 may include team contract assignments 426, equipment specifics 428, equipment service requirements and schedules 430, and equipment specific service professional assignments 432. Team contract assignments 426 may be a data store, table, or other data structure that stores information regarding the distribution of contracts to service teams. Among other information, team contract assignments 426 may primarily store a one-to-one relationship between a contract and a team. In other words, each contract may be associated with one team in contract team assignments 426. According to other various embodiments, different relationships, and/or intermediate relationships between contracts and teams may be established. For example, because each contract might cover multiple different site locations, one contract may be associated with many site identifiers, and each site identifier may be associated with one team. Equipment specifics 428 may store information regarding each piece of equipment that is related to each contract. For example, while not necessarily reflected on the face of the contract, equipment specifics 428 may store data relating to the fact that a certain contract site includes five air-handling units of a certain type. Equipment service requirements and schedules 430 may generally include service and schedule requests or requirements for each contract, site, and/or piece of equipment. For example, equipment service requirements and schedules 430 might include data that reflects that each of five air-handling units at a site include a certain filter that should be replaced every other month by a specialist. As some equipment may require a specialist or a customer may request a specialist or specific service professional, a user may associate a specific service professional with a piece of equipment, a customer site, or a contract independently of the team assignment in equipment specific service professional assignments 432. Detailed information about contracts, service requirements, equipment requirements, and other customer needs and requests may generally be characterized as service obligation data or service obligations.

Referring to FIG. 5A, a process of using a service alignment system is shown, according to an exemplary embodiment. A user of a service alignment system may begin the service alignment process by defining service resources (step 502). This step may include any number of verifying, entering, adding, deleting, and/or updating tasks as may be necessary to provide updated records of service resources. Service resources may be sufficiently updated when the user may be able to make informed assignment decisions based on the set of service resource data. Service resource data may be sufficiently updated when, for example, active service professionals have been entered, verified, and skills and skill levels have been associated with each service professional. Once resources have been defined, the user may assign resources to service obligations (step 504). This step may include relating a service obligation with at least one service professional or service fulfilling resource (e.g., a service team). This step may also include (or be precluded by) any number of service obligation definition activities such as verifying service obligations, entering service obligation details, adding service obligations, deleting service obligations, and/or otherwise updating service obligations. The service alignment system may then determine or provide detailed information to allow a user to determine whether or not the defined service obligations will be met (step 506) by the assigned service resources. If service obligations will be met, the process may end and the service alignment system or a subsequent system (e.g., a specific scheduling and tasking system of FIG. 3) may specifically schedule and create, print, and/or send (e-mail, text message, etc.) scheduling and assignment information to service resources (e.g., service professionals, service teams, service leaders, etc.). If service obligations will not be met, the process may loop back to step 502 and/or step 504 to iterate the system or user through an updating or assignment process as may be required to adequately meet the service obligations of the service provider. The determination regarding whether or not service obligations will be met may include verifying that all service contracts have at least one service resource assigned to the contract, verifying that the service resource assigned to the contract can complete the service obligations required by the contract under the time and/or budget allotted, verifying that any special contract or equipment needs are serviced by service professionals that are specialists, verifying that all service resources assigned to a contract includes some minimum set of skills, verifying that a minimum target skill set for the contract is collectively matched or exceeded by the skill set of the assigned service professionals, etc. The determination requirement may include a number of alternative or additional determination or verification steps as may be desirable to determine whether or not all service obligations have been sufficiently assigned service resources.

Referring to FIG. 5B, a more detailed process of using a service alignment system is shown, according to another exemplary embodiment. A user may begin the process by defining service teams (step 510). Defining service teams may include creating a number of service teams that roughly correspond with the number of major service obligations. Defining service teams may also include making preliminary or initial assignments of service professionals to service teams. Once teams have been defined, service team leadership may be assigned (step 512) to a service professional. The individual assigned to service team leadership may be a professional presently assigned to the team, an unassigned service professional, or to a professional assigned from a leadership or manager pool. Once some service teams have been created, a user may assign service teams to contracts (step 513). According to an exemplary embodiment, the service alignment system steps the user through a list of contracts, contract by contract, and the user may assign a team to a contract by browsing a list of unassigned teams or a list of teams with enough hours or days unassigned to service the contract. According to various alternative embodiments, the service alignment system may step the user through a list of service teams, team by team, and the user may assign a contract to a team by browsing and selecting from a list of unassigned contacts. Other or additional user interface steps and/or processes may be used to relate, match, or assign teams to contracts.

Referring further to FIG. 5B, at some point during the process, the user will be prompted to define contract specifics (step 516). This step may include, for example, defining variable or detail categories of “where,” “what,” “who,” “when,” and “why” for each contract. For example, this step may include identifying locations where service will be performed, identifying the equipment expected to be serviced as part of the contract, identifying what types of additional or optional services will be performed on the contract (e.g., unplanned visits, planned visits provided by the planned service estimator, etc.), identifying equipment specific specialist needs or assignments, identifying the coverage level for each piece of equipment or primary piece of equipment, and/or identifying when service visits should be performed under the contract or otherwise.

Once teams have been initially assigned in step 513 and contract specifics defined in step 516, it may be possible for the user and/or the system to refine service teams (step 518). According to various other embodiments, service teams may be refined before and/or after other steps of the process or continually refined as service obligations and teams are added. Refining service teams (step 518) may include receiving a user interface display, a report, and/or other indication or feedback from the service alignment system regarding service obligation requirements that are unmet by the present team compositions. Using this information, the user may add unassigned service professionals to a team or teams to correct for any detected deficiencies. According to an exemplary embodiment, the user may use this step to assign the vast majority of his service professionals to teams, using feedback relating to updated contract data (e.g., equipment data, etc.) to assign service professionals to teams efficiently the first time. According to various alternative embodiments, the user initially assigns users to teams and uses the feedback related to updated contract data to adjust the service professional to team assignments. The user may also or alternatively use a graphical user interface provided by the system to review each service professional to determine which team has the need for their skills. The system may also make any number of recommendations of service professional and/or team assignments or refinements based on processing of the service alignment system. The system may also use processing to provide instant and constant feedback if any service team does not have the service professionals with the necessary skills to meet the team's assigned service obligations. In addition to making skills-based adequacy determinations, this calculation or process may also determine whether each team has enough service professionals to execute the service tasks required under the contracts assigned to the team. The outcome of step 518 may be balanced service teams that are defined to sufficiently meet the service obligations of the service branch.

Referring yet further to FIG. 5B, the service alignment system may determine whether or not service obligations will be met (step 520). As previously mentioned, this step may occur during and/or after any of the previous steps. The system may also determine whether or not the workload is balanced among the teams (step 522). According to various exemplary embodiments, a graphical user interface or other indicators provided to the user by the system via the input/output devices may continually provide feedback in the form of aggregated results or notifications to the user during the user's defining and refining steps. According to yet other embodiments, the system automatically suggests optimized refinements for the user to review, accept, or reject after the user makes leadership and specialist assignments. The system may make these automatic optimization suggestions based on skills, schedule, distance from a professional's home or branch office to the service location, and/or any number of details that may help optimize service resource to obligation assignments. According to yet other embodiments, the system will make the initial team refinements or assignments for the user; and the user may then review the assignments provided by the system. If, at any time, the system or user determines that service obligations will not be met and/or that the workload is not balanced, the system or user may loop back to previous steps to provide additional definition of services and obligations and/or change assignments to make more sense based on the feedback provided by the system.

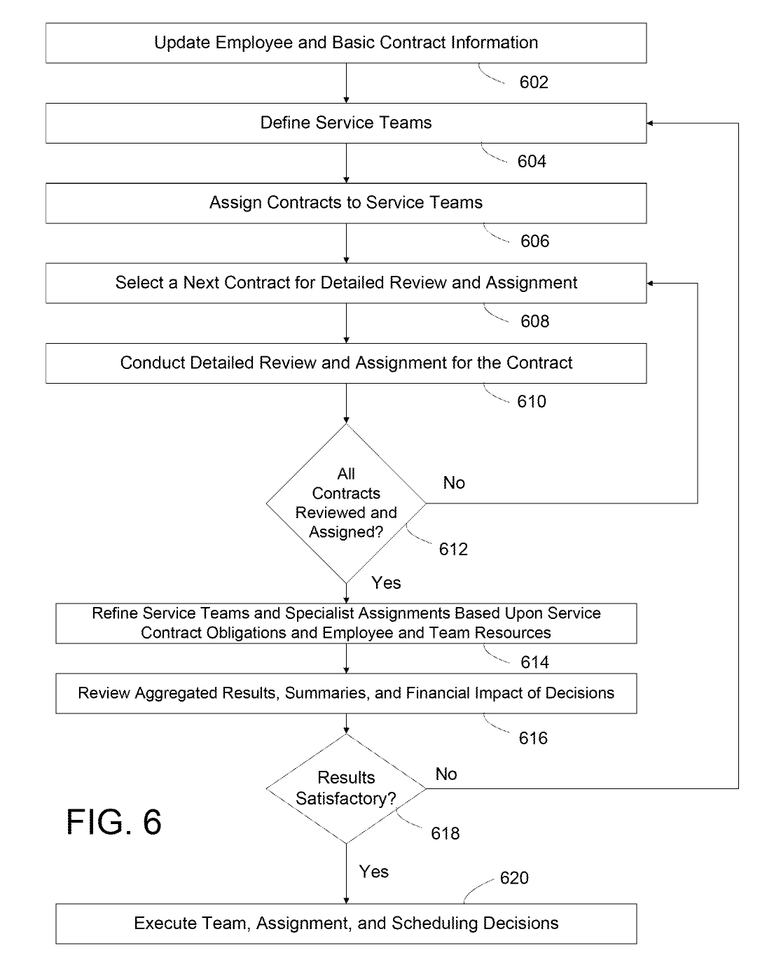

Referring to FIG. 6, a process of using a service alignment system to optimize service resources and meet contract obligations is shown, according to an exemplary embodiment. To prepare for service resource optimization, or as a first step, a user may first update service professional and basic contract information (step 602). This step may include verifying all employee or service professional information is updated in the system or in an outside system (e.g., a human resources system) that may provide an input to the service alignment system. This step also includes associating a selected skill set for each employee and/or assigning a skill level for one or more skills of the service professional. For example, if a service professional is skilled in servicing air-handlers, a user of the service alignment system may select or otherwise add a skill called “air-handler servicing” to a list of skills associated with the service professional. If the service professional is highly skilled, for example, the user may rank the service professional as having a skill level of 4.5 out of a possible 5 skill levels, and so on.

Once service professional data has been verified and/or updated, a user of a service alignment system may define service teams (step 604). This step may include identifying the number and types of teams that the user determines make sense to create based on the number of service professionals and/or the number of service obligations. For example, a user may determine that his industry's type of service work generally requires at least two people per team, and since he manages ten service professionals, five service teams will be created. During this process of creating teams, the user may assign particular service professionals to certain teams from a pool of unassigned service professionals. The user may continue assigning service professionals to teams until all service professionals have been assigned (i.e., the pool is empty). According to an exemplary embodiment, some service professionals may be removed from the pool of unassigned service professionals and not assigned to any particular team and instead assigned to a “floater team,” a specialist team, or designated as an individual specialist. For example, if a service branch only includes one electrical specialist, rather than assigning this specialist to any particular team, the user may be able to designate the professional as an electrical specialist who will float between teams, job sites, or contracts as his specialty services are needed. Using the service alignment system in this manner, a user may be able to implement, or begin to implement, a planned or envisioned team-based staffing model based on updated service professional and skills data.

Referring still to FIG. 6, once one or more teams have been created, a user may assign or distribute contracts to service teams (step 606). During this step, a graphical user interface may be provided to the user that assists the user in balancing the contract distribution evenly among teams or otherwise appropriately distributing contracts.

Once contracts have been distributed to teams, the user may begin selecting contract after contract (step 608) to conduct detailed review, assignment, and optimization tasks relating to the contract and/or the team. At this step, a user who is a service manager may delegate the rest of the optimization process or service alignment process to a service operations agent, team lead, or to an automated service alignment process. The service operations agent or team lead may then step through the contracts of a specific service team to conduct more detailed review and analysis. Regardless of who completes the detailed review and assignment for the selected contract, a user reviews each contract and team assignment in detail to further refine the contract and team details (step 610).

As each contract and assignment review is completed, the system may check to determine whether or not all contracts have been “aligned” or “completed” (step 612) and may prompt the user to review, assign, and/or align the next contract (i.e., loop back to step 608 for a next contract). If all contracts have been reviewed and assigned in detail, the system may provide a variety of feedback mechanisms via the graphical user interface. The user may use this feedback to refine service team and specialist assignments based upon service contract obligations, service professional, and team resources (step 614). For example, the system may be able to provide feedback that indicates a contract has been assigned to a team that requires condenser service and demands that a condenser-trained service professional service the condensers of the contract, but the assigned team does not presently include a condenser-trained service professional. Using this feedback, the user may take any number of refining actions or decisions including hiring another condenser-trained service professional, redefining the team to include a condenser-trained service professional, providing training for one or more present team members, assigning a floating specialist to the contract to handle condenser servicing, etc.

In addition to service alignment system feedback provided to the user for purposes of refining service teams and specialist assignments, the user may review one or more aggregated results, summaries, and/or financial impacts of the decisions made in any previous step (step 616). These aggregates may include, for example, a tally of tasks per month, staff plan recommendations, estimated hours per team, estimated hours per team member, forecasted labor demand, forecasted materials demand, forecasted profit margins, whether or not contracts should be changed and/or renegotiated, etc. These results and aggregates may be reviewed by the user and/or the system in determining whether or not the results of the service alignment process have been satisfactory (step 618). According to one exemplary embodiment, the system will guide the user's decision by suggesting, for example, that the results are not satisfactory and that more refinement or work is necessary. If the results are not satisfactory, the user may loop back to an early service alignment step such as step 604, defining the service teams. The user may iterate through the alignment process as required to obtain satisfactory and/or optimized results. According to an exemplary embodiment, the service alignment system will provide optimizing recommendations to the user to direct the user's iterative efforts. For example, the system may recommend that the user add at least one more team to handle a location of a contract that is “out of the way” for a particularly busy team. Once the results are satisfactory, the contracts or service obligations may be considered “aligned” and the aligned contracts may be executed (step 620) via a specific scheduling and tasking system (e.g., specific scheduling and tasking system 316 shown in FIG. 3). Contracts may also be executed on an ongoing basis and/or specific scheduling and tasking may be updated when the user moves onto a new contract.

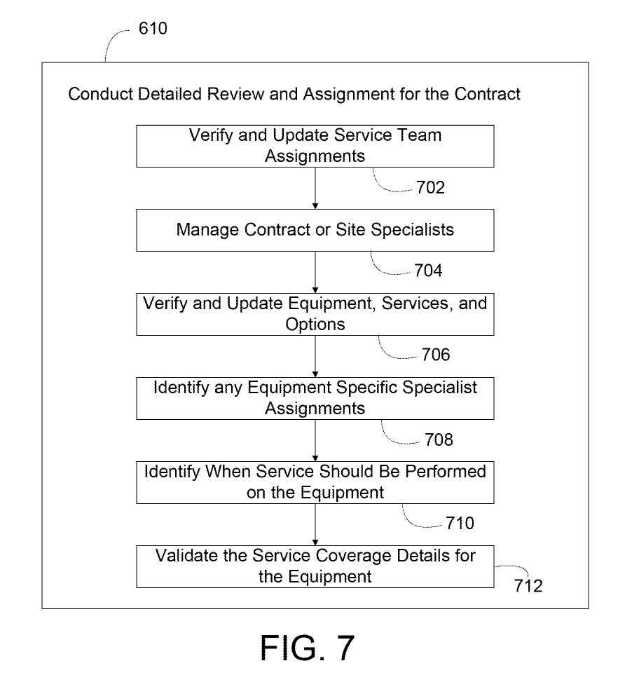

Referring to FIG. 7, a view of the sub-steps of the detailed review and assignment step 610 of FIG. 4 is shown, according to an exemplary embodiment. As each contract may have multiple sites or other easily separable locations or sets of obligations, it may be desirable to verify and update service team assignments for each site of a contract (step 702). This step may include verifying that the site list for the contract is complete and verifying that the site address information is correct. With this information verified and accessible, the service alignment system or a user may observe that the sites may be sufficiently serviced by the team assigned, that the sites are too geographically diverse for one team to service, and/or make any number of additional observations. This step may also generally help the user review and decide or define the questions of site location and edit team, leadership, specialist, or service professional assignments based on location.

After verifying team-level decisions for any given site or contract, the user may manage contract or site specialists for each contract or site (step 704). This type of specialist management may include estimating which specialist will best serve a site or contract and assigning that specialist to the site or contract.

Because service contracts may not include all service parameter details on their face, a user must verify and update equipment, services and options (step 706) for the contract and/or for each site of the contract, according to an exemplary embodiment. This step may include building a catalog or list of equipment from lists of possible equipment types or specific equipment models. The equipment, services, and options of a contract or site may be further defined or refined as service is done at the site and a service professional reports specific information to the service alignment system or user for entry into the system.

It may be desirable for a service providing entity to refrain from assigning some service professionals that are specialists to service teams. Other service providing entities may assign specialists to service teams, but also designate specialists as team-floating such that the specialist may help any number of teams with service tasks that may require the specialists' experience and/or skills. During the process of using the service alignment system, a user may identify equipment specific specialist assignments (step 708) that should be made for a contract and assign an appropriate specialist to the contract for the purpose of meeting the specialist requirement.

In addition to matching skill and experience of service resources such as service professionals and service teams to skill and experience contract requirements, a service contract may have certain temporal requirements and/or estimates. Therefore, a part of the user's and/or service alignment system's process may include identifying when service should be performed on the equipment (step 710). This step may include estimating how often service should be conducted, estimating how much time the service is expected to take (e.g., how many service professional hours are estimated), how many service professionals must be at the site at any given time to complete the tasks, the time slots of the day the client is available for consultation, and any number of additional or alternative steps to identify or define temporal requirements of the service obligation, contract, task, or equipment.

Because service coverage needs or expectations may vary from client to client and equipment piece to equipment piece, a user or the service alignment system may validate the service coverage details for the contract or the equipment (step 712). For example, validating the service coverage details for the contract may include considering, defining, storing or updating information such as budget information, detail level of the service, minimum skill level of the service professionals working on the equipment, equipment specific needs (e.g., replace the filters), levels of service (e.g., premium, standard, silver, gold, etc.), and any additional or alternative service details.

While this application refers to a single service providing entity as a service branch, it should be appreciated that the service alignment system and methods described above could be implemented in a variety of industries (e.g., technology, building services, etc.) and at a variety of levels (e.g., division, district, team).

According to various preferred embodiments, the service alignment system is a service alignment system for building services such as HVAC and security services. In the context of building services, the system or method may include a highly detailed equipment mapping step during the contract defining or service obligation defining processes. The service alignment system may receive inputs from a building management or HVAC management system to conduct this highly detailed equipment mapping. For example, the service alignment system may download or otherwise receive data relating to site details, zone data, controllers, air handlers, diagnostics, field controllers, field devices, sensors, actuators, temperatures, or other information from a networked building management system such as the METASYS® Building Management System sold by Johnson Controls, Inc. More particularly, the service alignment system may integrate or remotely connect to an application data server or network automation engine of the METASYS® system or another building management system to catalog and/or monitor the devices at a contract site.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

The present application contemplates methods, systems and program products on any machine-readable media for accomplishing its operations. The embodiments of the present application may be implemented using an existing computer processors, or by a special purpose computer processor for an appropriate system, incorporated for this or another purpose or by a hardwired system.

It is important to note that the construction and arrangement of the service alignment system as shown in the various exemplary embodiments is illustrative only. Although only a few embodiments have been described in detail in this disclosure, those skilled in the art who review this disclosure will readily appreciate that many modifications are possible without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

As noted above, embodiments within the scope of the present application include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

It should be noted that although the figures herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application. Likewise, software implementations could be accomplished with standard programming techniques with rule based logic and other logic to accomplish the various connection steps, processing steps, comparison steps and decision steps.

What is claimed is:

1. A method for creating and executing a service strategy using a service alignment system, comprising:
updating a skill set of a service professional available to perform service;
defining a service team, wherein service professionals may be assigned to the service team;
assigning the service team to a contract;
updating service obligations associated with the contract;
assigning a service professional available to perform service to the service team assigned to the contract by matching a skill of the service professional to an updated service obligation of the contract; and
storing and executing the team and service professional assignments using the service alignment system.

2. The method of claim 1, wherein updating service obligations associated with the contract comprises receiving and storing a set of equipment to be serviced under the contract.

3. The method of claim 2, wherein updating service obligations associated with the contract further comprises receiving and storing a set of minimum skill requirements related to the set of equipment.

4. The method of claim 1, further comprising determining whether the contract will be adequately fulfilled by the assigned service team by comparing a set of skill requirements related to the service obligations of the contract to skill sets of the assigned service team's service professionals.

5. The method of claim 1, wherein updating service obligations associated with the contract comprises relating skills to the contract that are estimated to be required for satisfactory execution of the contract.

6. The method of claim 1, further comprising receiving a contract and provisional service obligation data from a contract basics system.

7. The method of claim 1, wherein updating service obligations associated with the contract comprises receiving service obligations from a planned service estimator.

8. The method of claim 1, further comprising balancing the amount of work assigned to at least two service teams such that no team is estimated to complete disproportionately more work per assigned service professional than any other service team.

9. The method of claim 1, further comprising defining a service team leader for the service team.

10. The method of claim 9, further comprising generating a contract to service team assignment recommendation by comparing stored properties of the service team leader with contract service obligations.

11. The method of claim 1, wherein the method further comprises generating a report that displays a difference set between a requirement set of the service obligations and properties of the assigned service team.

12. The method of claim 1, wherein the method further comprises generating a report that displays an estimated number of additional service professionals needed to meet a requirement set of the service obligation.

13. The method of claim 1, wherein the method further comprises iteratively refining which service professionals are assigned to a service team until the service obligations related to the service team are estimated to be adequately completed.

14. The method of claim 1, wherein executing the team and service professional assignments includes communicating the service resource assignment to the service resource.

15. The method of claim 1, wherein executing the team and service professional assignments includes sending the service resource assignment to a scheduling system.

16. The method of claim 1, wherein executing the team and service professional assignments includes scheduling the service professional to meet the service obligation.

17. The method of claim 1, wherein executing the team and service professional assignments includes printing a report of service assignments.

18. A system for aligning service obligations with service resources, comprising:
one or more databases communicably coupled to a computer system, the one or more databases comprising:
a service obligations data set comprising a set of contracts and defined service obligations for each contract, and
a service resources data set comprising a plurality of service teams and service professionals;
a service alignment engine configured to functionally access the one or more databases, assign each contract to a service team, and to build the service team by assigning service professionals to the service team; wherein the service alignment engine is further configured to iterate a computer system user through a process of refining the service professional to service team assignments if the service alignment engine estimates that the defined service obligations for each contract will not be adequately served by the team assigned to the contract; and
a scheduling system configured to receive and execute the assignments.

19. The system of claim 18, wherein the defined service obligations for each contract include equipment and skills required to service the equipment.

20. The system of claim 19, wherein the service alignment engine is further configured to determine whether the service team assigned to the contract includes service professionals having the skills required to service the equipment.

21. The system of claim 18, wherein the service alignment engine is communicably coupled to a building management system.

22. The system of claim 21, wherein the service alignment engine is further configured to populate defined service obligations for contracts using data received from the building management system.

23. The system of claim 18, wherein the computer system is configured to archive and display the service team and service professional assignments.
